(19) United States
(12) Patent Application Publication
(10) Pub. No.: US 2016/0306933 A1
(43) Pub. Date: Oct. 20, 2016

(54) MOBILE MEDICAL DOCUMENTATION IN A HOSPITAL INFORMATION SYSTEM

(71) Applicant: AGFA HEALTHCARE, Bonn (DE)

(72) Inventors: Raphael WITTMANN, Mortsel (BE); Gerhard LACKNER, Mortsel (BE)

(21) Appl. No.: 15/102,636

(22) PCT Filed: Dec. 16, 2014
(86) PCT No.: PCT/EP2014/077979

§ 371 Date: Jun. 8, 2016

(30) Foreign Application Priority Data
Dec. 19, 2013 (EP) 13198319.9

(51) Int. Cl. G06F 19/00; G06F 17/24; G10L 15/26

(52) U.S. Cl. CPC G06F 19/327; G10L 15/26; G06F 17/243

(57) ABSTRACT

A method for creating medical documentation in a hospital information system uses a mobile device, in which a target form is created in the hospital information system as a result of an adapted process for communicating an optimized form definition to a mobile device, which is then used to collect and record the necessary data for the target form using an intermediary data structure called a dummy form. The dummy form is a limited version of the target form (containing a subset of the data of the target form), but behaves in the hospital information system as a target form. A part of the data is captured as digitally recorded multimedia content, which may transcribed later on as text in the target form.

### CROSS-REFERENCE TO RELATED APPLICATIONS

This application is a 371 National Stage Application of PCT/EP2014/077979, filed Dec. 16, 2014. This application claims the benefit of European Application No. 13198319.9, filed Dec. 16, 2013, which is incorporated by reference herein in its entirety.

### BACKGROUND OF THE INVENTION

1. Field of the Invention

The present invention relates to medical documentation in a mobile environment, more specifically dictation on a mobile device in a clinical or hospital environment.

2. Description of the Related Art

A Hospital Information System (HIS) is a comprehensive, integrated information system designed to manage all the aspects of a hospital operation, such as medical, administrative, financial, legal and the corresponding service processing. Traditional approaches encompass paper-based information processing as well as resident work position and mobile data acquisition and presentation.

In recent years there has been a transition from hospital information systems for administrative purposes towards more dedicated clinical information systems to support clinical workflow and decision making.

Usage of stored clinical data in the HIS, and entry of new clinical data in the HIS tends to happen more often in the vicinity of the patient, which is the reason why mobile applications are becoming gradually more important in this context. Clinical data collection such as recording vital signs (blood pressure, temperature, . . . ), general reporting about the patients' condition by the physician during his rounds, tracking and recording the treatment actions by the clinical staff (medication) are more often taking place under mobile conditions.

A side effect of this evolution is that the complexity of the applications which are being used in the mobile environment is increasing in terms of application scope for consulting clinical data or reporting. While clinical applications allow for retrieving and display a wide range of clinical information (such as medical images, reports, lab results, . . . ), the reporting applications offer a variety of different report types which are often unique for each hospital and department.

Mobile users of a HIS expect that most functionality of the applications on their desktop PC's or terminals is also available on the mobile device. It is a challenge to offer all available functionalities of an existing hospital information system (HIS) on mobile devices (such as a tablet), and more specifically functionalities required by the clinical staff during their rounds with the patients. Many of the functionalities needed in this mobile environment require dictation functionality.

Today, this medical documentation is already realized within the standard HIS via hundreds of specific predefined forms for use in the hospital environment, but is not extended fully towards mobile devices (such as a tablet computer, smartphone, . . . )

### SUMMARY OF THE INVENTION

The above-described aspects are solved by a method as set out below.

The present invention provides a method for creating medical documentation in a hospital information system and more specifically a method to create this documentation on a mobile device. In this invention, a simplified target form is created in this HIS as a result of an adapted process for communicating an optimized form definition (also called “simplified mobile interface definition”) to a mobile device, which is then used to collect and record the necessary data for the target form, by use of an intermediary data structure called the “dummy form”. The simplified target form is the displayed instance of the “dummy form” on the mobile device.

The “dummy form” has to be understood as a minimal generic form (for instance: a minimal generic form for dictation) which is specifically designed to only provide the minimum form features to perform the intended data collection action (such as a dictation) and to keep the result associated with the correct patient and study context.

For each target form which needs to be deployed on a mobile device using this technique, will exist a corresponding and predefined simplified target form definition in the HIS. In this case, the target form can be rendered on the mobile device in its simplified form. The data collected through this simplified target form will be stored in the “dummy form”. The same simplified target form definition may be associated (and thus used) with different target forms in the HIS, serving then a similar function (such as dictation) within the frame of the target form.

In the context of this invention, the “dummy form” is a limited data structure version of the target form (containing a subset of the data of the target form), but behaves in the system as a target form in the sense that it will show up in worklists for the users as not completed by a workflow, just the same as a target form would show up when being created. Part of the data in one preferred embodiment of this invention is captured as digitally recorded multimedia content, which may be transcribed later on as text in the target form.

After its creation (for instance and in the case of a dictation: after the recording is completed), the “dummy form” will be stored in the system as an intermediate data structure which will only be differentiated into its final target form shape when it is “picked up” by the transcriptionist and enters it into a HIS workflow.

The present invention is advantageous in that it solves the conflicting implementation approaches of the mobile and client version in an efficient and innovative way. The invention allows for capturing clinical data (e.g. a dictation) using a dedicated—but minimal or simplified—interface to perform the data collection efficiently on mobile devices without being hindered by the complexities of typical target forms stored in a HIS.

In the context of this invention, medical documentation is the collection of the different forms containing clinical information from a patient stored in the HIS. These forms are defined by the specific configured templates in the HIS for a specific hospital or department. A default configuration is usually provided for by the manufacturer of the HIS as a set of default templates, standards and frameworks. This set is later on further adapted by the hospital to meet the exact requirements of its workflows.

The different forms constitute different types of medical reports (like discharge letters, operative- , pathology- and lab reports, . . . ), which may have different appearances (long, short, electronic or printable versions), and which may have different contents (anamnesis, diagnosis, treatment information, patient information, medication plan, . . . )

A medical documentation form is defined within the HIS as a single instance of a form definition. The form definition describes the content (editable by the user or calculated automatically), the rules, the available functionalities and work flow options for a form instance within the HIS frame work.

In the context of this invention, the target form is the specific instance of a form which is going to be created in the HIS as a result of the invention. Especially the conditions on validity, visualization and print make a form very flexible and unique. The resulting target form has identical characteristics of the form as if it would have been created on a normal client computer used with the HIS.

The invention uses a simplified GUI (or simplified target form instance) to capture the data to be collected on the mobile device, and a dummy form to store the said data. The simplified GUI is designed in such way to reduce the complexity of the design and functionality of the full target form during graphic presentation on the mobile device.

The simplified GUI for collection of clinical data (such as for instance: a dictation) is defined ahead and stored as a simplified mobile interface definition in said HIS, and can thus be retrieved and displayed for each target form from said HIS.

Specific examples and preferred embodiments are set out below.

In one preferred embodiment, the mobile device can be any type of mobile device having computational, display, input (touch screen, virtual mouse and keyboard) and recording functionality.

In a further preferred embodiment, the multimedia data are audio data further providing e.g. spoken documentation and comments from clinicians, the clinical status of the patient to allow vocal transcription processes resulting in a transcription text which is to be stored in the medical documentation.

The present invention is advantageous in that it can offer important functionalities of an existing hospital information system (HIS) on mobile devices (such as a tablet), and more specifically functionalities required by the clinical staff during their rounds with the patients.

The present invention can be implemented as a computer program product adapted to carry out the steps set out in the description.

The computer executable program code adapted to carry out the steps set out in the description can be stored on a computer readable medium.

Further advantages and preferred embodiments of the present invention will become apparent from the following description and drawings.

### BRIEF DESCRIPTION OF THE DRAWINGS

FIG. 1 shows a conceptual view of a HIS according to a preferred embodiment of the present invention, it depicts the different procedure steps in this invention together with the different datastructures and system elements.

FIG. 2 is a preferred embodiment of a simplified GUI showing a patient worklist and a selection list of report types.

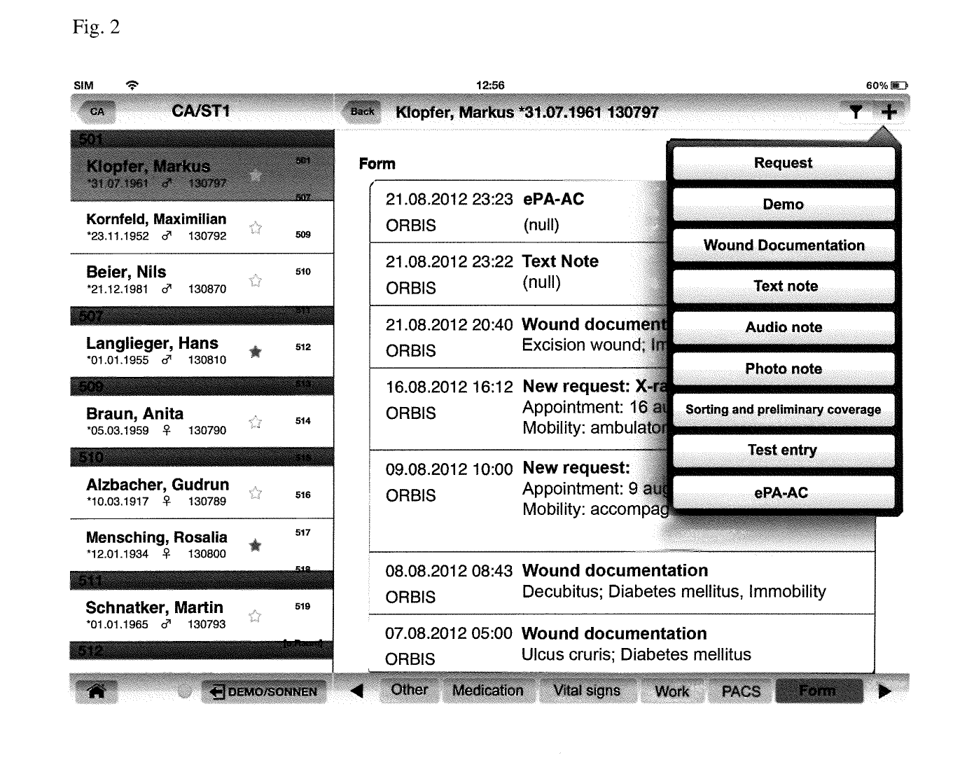

FIG. 3 is a preferred embodiment of a simplified GUI showing a dictation module.

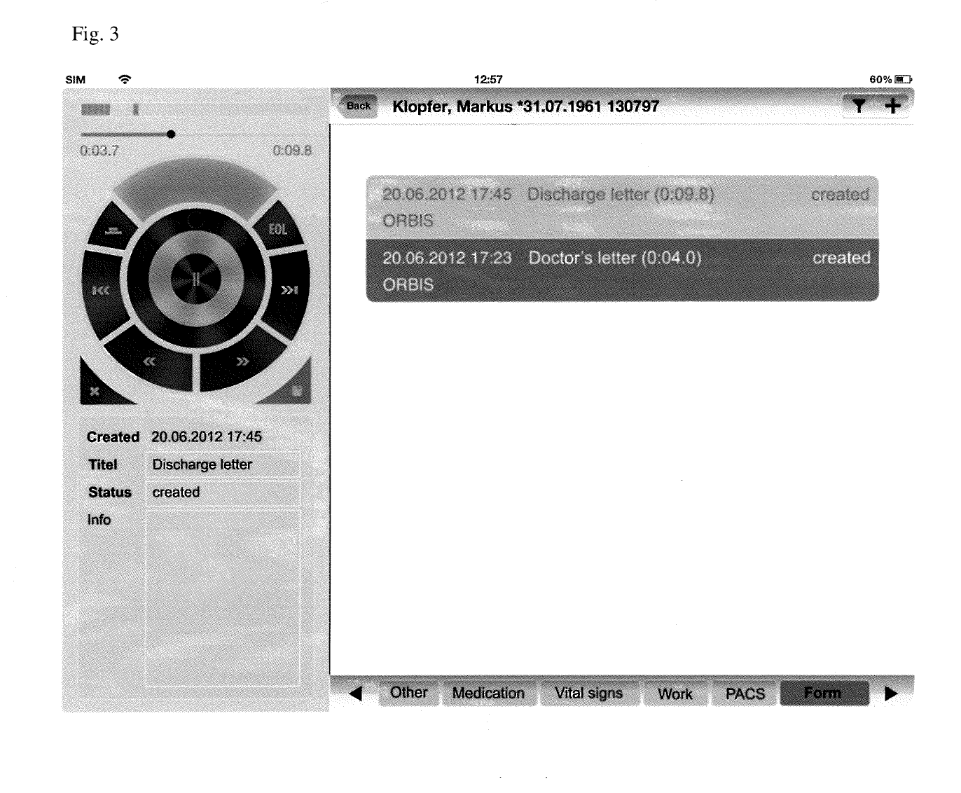

FIG. 4 is a preferred embodiment of a simplified GUI showing the medication plan for a patient.

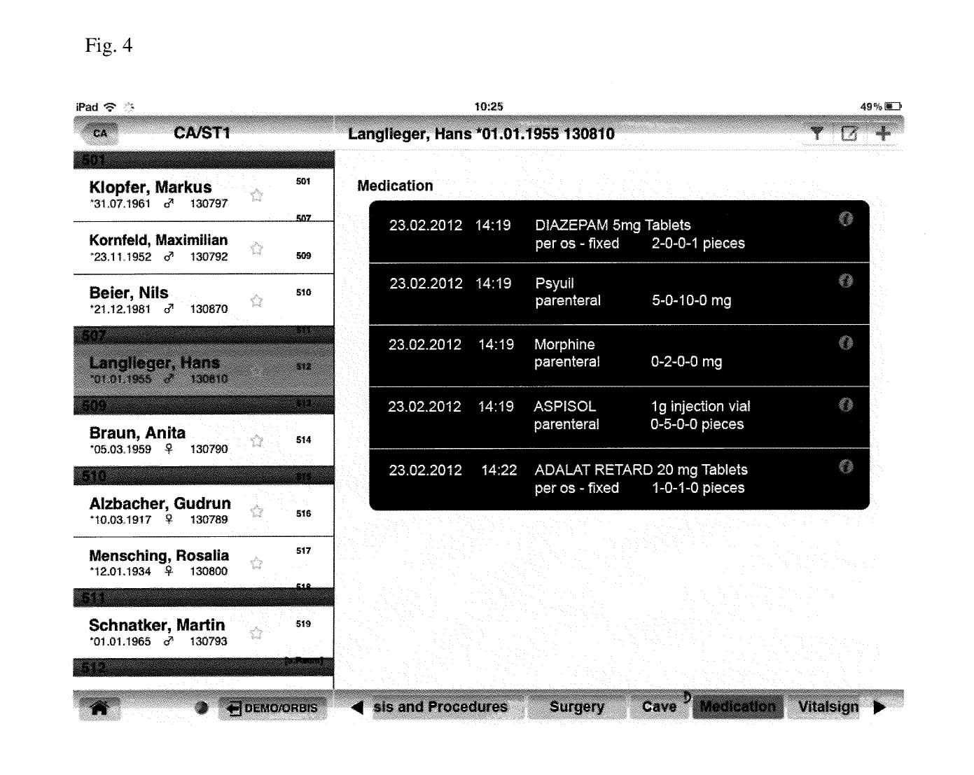

FIG. 5 is a preferred embodiment of a simplified GUI showing the lab results overview for a patient.

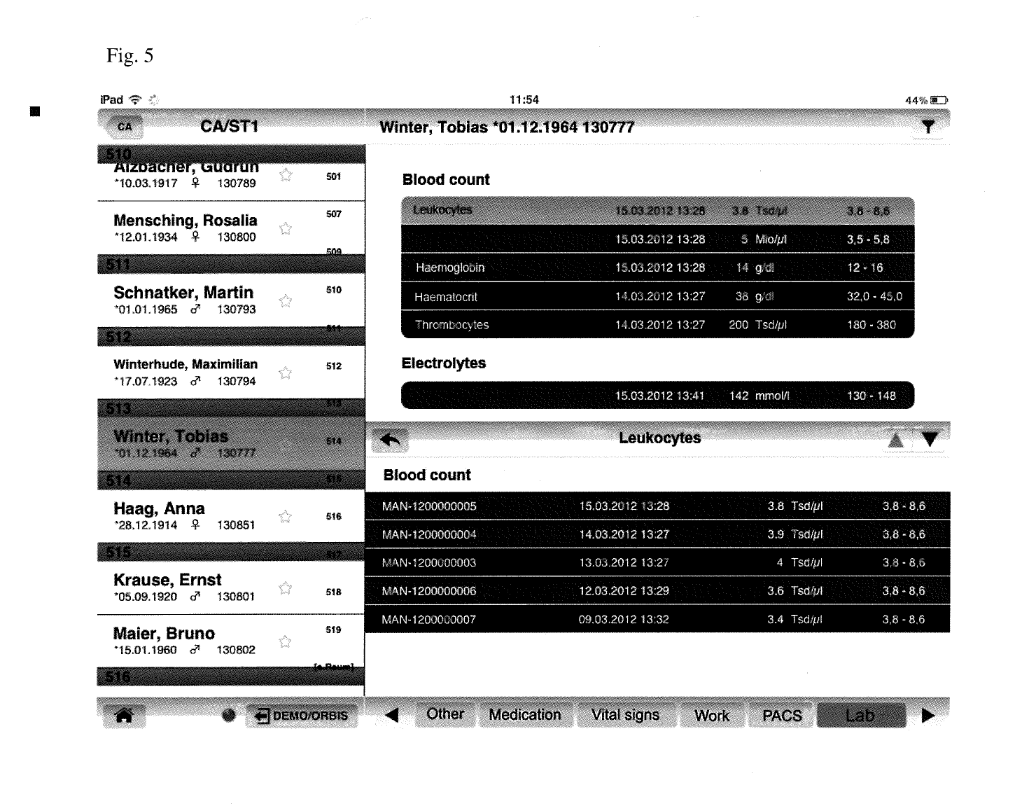

### DETAILED DESCRIPTION OF THE PREFERRED EMBODIMENTS

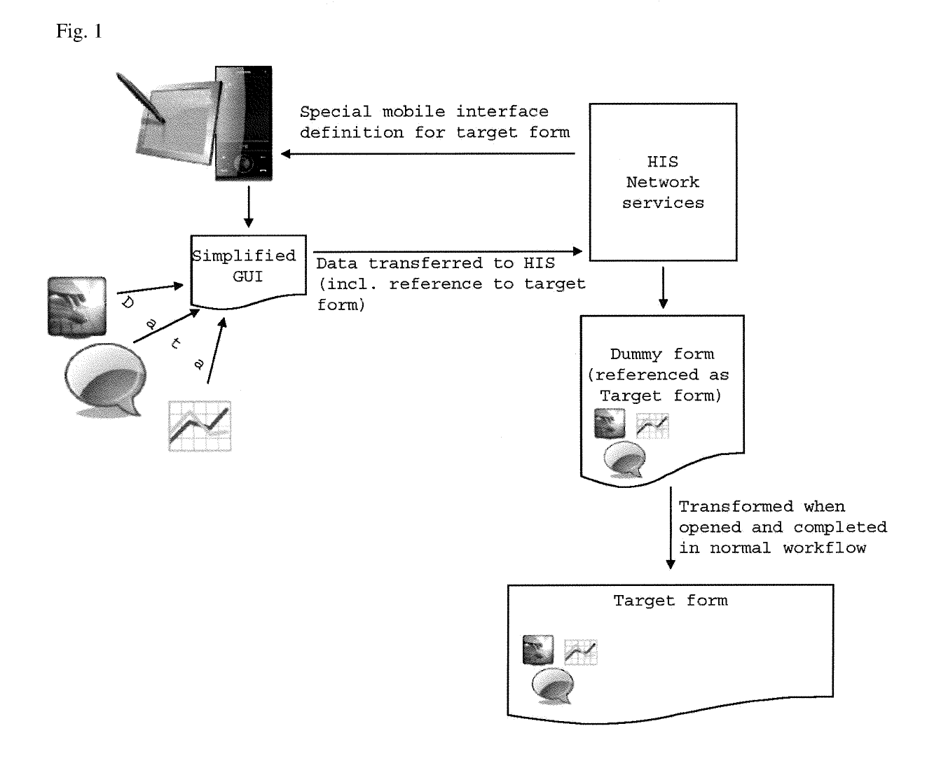

A method for creating medical documentation in a hospital information system according to the present invention is shown in FIG. 1, and mainly consists of the steps of
a. communicating a simplified mobile interface definition of a target form from said HIS to a mobile device upon request of the user, the simplified mobile interface definition being defined in advance for each target form and retrieved from said HIS, the simplified interface definition comprising a limited subset of data and data entry fields compared to a target form, then
b. rendering of a simplified target form instance on the mobile device as a GUI, optionally allowing the selection of the target form type. Then,
c. generating multimedia data on the mobile device in the form of a digital file, and transferring this data file to said HIS, followed by
d. creating a dummy form on the HIS containing transferred data and optionally including a reference to a final target form, whereby the dummy form behaves in the HIS as said final target form, and whereby the dummy form will be transformed into said final target form as soon it is entered in a workflow on the HIS.

One of the use cases for a mobile version is that the physician can dictate notes and comments into the mobile edition during rounds, but without knowing all the explicit data, validity conditions, etc. of the specific target form in the HIS.

In addition, the amount of data and GUI elements available on a mobile version of this HIS has a reduced scope in comparison to the full client version.

Still the dictation must be available throughout the HIS in a fully integrated way (which means availability on form level) to allow the author or a secretary to play it back and transcribe the actions and results into the HIS by using specific dictation modules. For the secretary the origin of the playback, such as client, mobile device or other devices is not relevant. On the contrary the dictations which were accomplished on a mobile device have to seamlessly integrate into all the standard forms and workflows of the system.

The communication step of the interface definition to the mobile device is triggered by a command on the mobile device via a web interface. In this step, the type of form (eventually the subtype) is selected for the patient, after which the trigger command is given to initiate the communication step. The mobile interface definition contains the specification of the data structure of the selected report type, and is transferred in generic XML-format to the mobile device.

The application on the mobile device is able to render a simplified GUI based on the said transferred interface definition, and is capable of collecting data input defined by the said interface definition. The simplified GUI in one preferred embodiment only contains data fields for the patient identification data, the case data, an optional selection box for the intended final target form and the input controls to record an audio file. The GUI is simplified compared to the original version of the target form, and capable of collecting the minimal clinical data such as the patient identification information, and the reference to the type of target form.

The simplified GUI allows for generating the multimedia data, by a recording device (microphone, camera) associated with the mobile device, and multimedia recording software. The multimedia data is stored in digital file format which meets the industry standard requirements for medical dictation. In a specific preferred embodiment of this invention, the multimedia data is recorded dictation audio data, captured by a microphone and audio recording software.

The GUI also provides for entering supplementary data as foreseen by the simplified GUI. All data are collected on the mobile device and temporarily stored in digital format.

After the collection of data is completed on the mobile device, the said data is combined with the minimal clinical data (such as patient identification information, reference to the type of target form) and then transferred over the network relying on standard webservices provided by the HIS system.

After a successful transfer and receipt confirmation of all data on the HIS, the dummy form will be created in the system and all said transferred data will be stored therein. The dummy form is a temporary data structure in the HIS containing the reference to the form type of the target form, which allows it to behave as if it were a target form in the HIS. It means that the dummy form will appear in the worklists and workflows in the HIS, as if it were an instance of the final target form created on a regular client workstation or terminal.

As soon as the dummy form is opened for further processing, editing, transcription or any other further activity step in the workflow of the HIS, the dummy form will be transformed into the intended target form. In this step, all stored data will be appropriately transferred to the datastructure of the target form. After a successful transformation into the target form, the dummy form will be cancelled in the HIS and will cease to exist.

1-5. (canceled)

6. A method for creating medical documentation in a hospital information system (HIS), the method comprising the steps of:
communicating a simplified mobile interface definition of a target form from the HIS to a mobile device upon request of a user, the simplified mobile interface definition being defined in advance for the target form and retrieved from the HIS, the simplified interface definition including a limited subset of data and data entry fields compared to the target form;
rendering a simplified target form on the mobile as a graphical user interface;
generating multimedia data on the mobile device in a digital data file, and transferring the digital data file to the HIS;
creating a dummy form on the HIS including the multimedia data; wherein
the dummy form functions in the HIS as a final target form; and
the dummy form is transformed into the final target form as soon as the dummy form is entered in a workflow on the HIS.

7. The method according to claim 6, wherein the limited subset of data is a minimum amount of data to perform an intended data collection action.

8. The method according to claim 6, wherein the digital data file includes dictation audio data.

9. The method according to claim 8, wherein the dictation audio data represents medical report content.

10. The method according to claim 9, further comprising the step of transcribing the dictation audio data into text.

11. The method according to claim 6, wherein the step of rendering the simplified target form includes allowing selection of a target form type.

12. The method according to claim 6, wherein the dummy form includes a reference to the final target form.
